(19) United States
(12) Patent Application Publication
(10) Pub. No.: US 2016/0018949 A1
(43) Pub. Date: Jan. 21, 2016

(54) GLASS SHEET HAVING HIGH INFRARED RADIATION TRANSMISSION

(71) Applicant: AGC GLASS EUROPE, Louvain-La-Neuve (BE)

(72) Inventors: Thomas LAMBRICHT, Perwez (BE); Audrey DOGIMONT, Sart-Dames-Avelines (BE)

(73) Assignee: AGC GLASS EUROPE, Louvain-La-Neuve (BE)

(21) Appl. No.: 14/773,489

(22) PCT Filed: Mar. 12, 2014
(86) PCT No.: PCT/EP2014/054805

§ 371 Date: Sep. 8, 2015

(30) Foreign Application Priority Data
Mar. 20, 2013 (BE) BE 2013/0180

(51) Int. Cl. G06F 3/042; C03C 4/10; C03C 3/087

(52) U.S. Cl. CPC G06F 3/0421; C03C 3/087; C03C 4/10; C03C 2204/00; G06F 2203/04109

(57) ABSTRACT

The invention relates to a glass sheet having high infrared radiation transmission, intended, in particular, for use in a touch tablet, panel or screen. More specifically, the invention relates to a glass sheet having a composition comprising, concentrations expressed as a percentage of the total weight of the glass: 55-78% SiO2; 0-18% Al2O3; 0-18% B2O3; 5-20% Na2O; 0-15% CaO; 0-10% MgO; 0-10% K2O; 0-5% BaO; 0.002-0.06% total iron (expressed as Fe2O3), and cobalt (expressed as CoO) varying between 0.001 and 1%.

### 1. FIELD OF THE INVENTION

The present invention relates to a glass sheet having a high transmission in the infrared. The general field of the invention is that of optical touch panels placed over zones of display surfaces.

Specifically, by virtue of its high transmission in the infrared (IR), the glass sheet according to the invention may advantageously be used in a touch screen, touch panel or touch pad using the optical technology called planar scatter detection (PSD) or even frustrated total internal reflection (FTIR) (or any other technology requiring a high transmission in the IR) to detect the position of one or more objects (for example a finger or stylus) on a surface of said sheet.

Consequently, the invention also relates to a touch screen, a touch panel or a touch pad comprising such a glass sheet.

### 2. PRIOR-ART SOLUTIONS

PSD and FTIR technologies allow multi-touch touch screens/panels that are inexpensive and that may have a relatively large touch surface (for example from 3 to 100 inches in size) and a small thickness, to be obtained.

These two technologies involve:

(i) injecting infrared (IR) radiation, using LEDs for example, into a substrate that is transparent in the infrared, from one or more edges/edge faces;
(ii) propagating the infrared radiation inside said substrate (which then plays the role of a waveguide) via a total-internal-reflection optical effect (no radiation “escapes” from the substrate);
(iii) bringing the surface of the substrate into contact with some sort of object (for example, a finger or a stylus) so as to cause a localized disturbance by scattering of radiation in all directions; certain of the deviated rays will thus be able to “escape” from the substrate.

In FTIR technology, the deviated rays form a spot of infrared light on the lower surface of the substrate, i.e. on the surface opposite the touch surface. These deviated rays are detected by a special camera located behind the device.

For its part, PSD technology involves two additional steps after steps (i)-(iii):

(iv) analysing, with a detector, the resulting IR radiation at the edge of the substrate; and
(v) calculating, algorithmically, the position(s) of the object(s) making contact with the surface, from the detected radiation. This technology is especially described in document US 2013/021300 A1.

Fundamentally, glass is a material of choice for touch panels due to its mechanical properties, its durability, it scratch resistance, its optical transparency and because it can be chemically or thermally toughened.

In the case of the glass panels used in PSD or FTIR technology and of very large area and therefore of a relatively large length/width, the optical path of the injected IR radiation is long. In this case, absorption of the IR radiation by the material of the glass therefore has a significant effect on the sensitivity of the touch panel, which may then undesirably decrease over the length/width of the panel. In the case of glass panels used in PSD or FTIR technology and of smaller area, and therefore with a shorter optical path of the injected IR radiation, the absorption of the IR radiation by the material of the glass also has an effect, in particular on the power consumption of the device incorporating the glass panel.

Thus, a glass sheet highly transparent in the infrared is extremely useful in this context, in order to guarantee undegraded or satisfactory sensitivity over the entirety of the touch surface when this surface is large in area. In particular, a glass sheet having an absorption coefficient at a wavelength of 1050 nm, which wavelength is generally used in these technologies, equal to or even smaller than 1 m⁻¹ is ideal.

In order to obtain a high transmission in the infrared (and in the visible), it is known to decrease the total iron content in the glass (expressed in terms of Fe₂O₃ according to standard practice in the field) and thus obtain a glass with a low iron content (or “low iron” glass). Silicate glass always contains iron because the latter is present as an impurity in most of the batch materials used (sand, limestone, dolomite, etc.). Iron exists in the structure of the glass in the form of ferric ions Fe³⁺ and ferrous ions Fe²⁺. The presence of ferric ions Fe³⁺ makes the glass weakly absorbing at short wavelengths in the visible and strongly absorbing in the near ultraviolet (absorption band centred on 380 nm), whereas the presence of ferrous ions Fe²⁺ (sometimes expressed in FeO oxide) is responsible for strong absorption in the near infrared (absorption band centred on 1050 nm). Thus, increasing total iron content (content of iron in its two forms) accentuates absorption in the visible and infrared. In addition, a high concentration of ferrous ions Fe²⁺ decreases transmission in the infrared (in particular in the near infrared). However, to attain an absorption coefficient that is sufficiently low for touch applications at the wavelength of 1050 nm merely by changing total iron content would require such a large decrease in this total iron content that (i) it would lead to production costs that would be much too high, due to the need for very pure batch materials (materials of sufficient purity in certain cases not even existing), and (ii) it would cause production problems (especially premature wear of the furnace and/or difficulties with heating the glass in the furnace).

It is also known, to further increase the transmission of the glass, to oxidize the iron present in the glass, i.e. to decrease the number of ferrous ions to the gain of ferric ions. The degree of oxidation of a glass is given by its redox ratio, defined as the ratio by weight of Fe²⁺ atoms to the total weight of iron atoms present in the glass i.e. Fe²⁺/total Fe.

In order to decrease the redox ratio of the glass, it is known to add an oxidizing agent to the blend of batch materials. However, most known oxidants (sulphates, nitrates, etc.) do not have a high enough oxidation power to attain the IR transmission values sought for touch-panel applications using FTIR or PSD technology.

### 3. OBJECTIVES OF THE INVENTION

One objective of the invention, in at least one of its embodiments, is to provide a glass sheet having a high transmission in the infrared. In particular, the objective of the invention is to provide a glass sheet having a high transmission in the near infrared.

Another objective of the invention, in at least one of its embodiments, is to provide a glass sheet that, when it is used as a touch surface in large-area touch screens, touch panels or touch pads, causes little or no decrease in the sensitivity of the touch function.

Another objective of the invention, in at least one of its embodiments, is to provide a glass sheet that, when it is used as a touch surface in more modestly sized touch screens, touch panels or touch pads, has an advantageous effect on the power consumption of the device.

Another objective of the invention, in at least one of its embodiments, is to provide a glass sheet having a high transmission in the infrared and having an acceptable appearance for the chosen application.

Finally, another objective of the invention is to provide a glass sheet having a high transmission in the infrared and that is inexpensive to produce.

### 4. SUMMARY OF THE INVENTION

The invention relates to a glass sheet having a composition that comprises, in an amount expressed in percentages by total weight of glass:

| | |
|---|---|
| SiO₂ | 55-78% |
| Al₂O₃ | 0-18% |
| B₂O₃ | 0-18% |
| Na₂O | 5-20% |
| CaO | 0-15% |
| MgO | 0-10% |
| K₂O | 0-10% |
| BaO | 0-5% |
| Total iron (expressed in Fe₂O₃ form) | 0.002-0.06%; |

According to one particular embodiment, said composition furthermore comprises a cobalt content (expressed in CoO form) ranging from 0.001 to 1% by weight relative to the total weight of the glass.

Thus, the invention is based on an approach that is completely novel and inventive because it allows the stated technical problem to be solved. Specifically, the inventors have demonstrated that surprisingly it is possible, by combining in a glass composition a low iron content and cobalt, particularly known as a powerful colouring agent in tinted glass compositions, within a specific content range, to obtain a glass sheet that is very transparent in the IR, without having too much of a negative effect on its appearance and colour.

Throughout the present text, when a range is indicated it is inclusive of its limits. Furthermore, each and every integer value and sub-range in a numerical range are expressly included as though explicitly written. Furthermore, throughout the present text, percentage amount or content values are values by weight expressed relative to the total weight of the glass.

Other features and advantages of the invention will become more clearly apparent on reading the following description.

The term “glass” is understood, according to the invention, to mean a totally amorphous material, therefore excluding any even partially crystalline material (such as, for example, vitrocrystalline or glass-ceramic materials).

The glass sheet according to the invention may be made of glass belonging to various categories. The glass may thus be soda-lime-silica glass, aluminosilicate glass, borosilicate glass, etc. Preferably, and for reasons of lower production cost, the glass sheet according to the invention is a sheet of soda-lime-silica glass. In this preferred embodiment, the composition of the glass sheet may comprise, in an amount expressed in percentages by total weight of glass:

| | |
|---|---|
| SiO₂ | 60-75% |
| Al₂O₃ | 0-4% |
| B₂O₃ | 0-4% |
| CaO | 0-15% |
| MgO | 0-10% |
| Na₂O | 5-20% |
| K₂O | 0-10% |
| BaO | 0-5% |
| Total iron (expressed in Fe₂O₃ form) | 0.002-0.06%. |

The glass sheet according to the invention may be a glass sheet obtained by a float process, a drawing process, or a rolling process or any other known process for manufacturing a glass sheet from a molten glass composition. According to a preferred embodiment according to the invention, the glass sheet is a sheet of float glass. The expression “sheet of float glass” is understood to mean a glass sheet formed by the float process, which consists in pouring molten glass onto a molten tin bath under reducing conditions. As is known, a sheet of float glass has what is called a “tin side”, i.e. a side on which the region of the glass near the surface of the sheet is enriched with tin. The expression “enriched with tin” is understood to mean an increase in tin concentration with respect to the composition of the core of the glass, which may be substantially zero (free of tin) or not.

The glass sheet according to the invention may be various sizes and relatively large. It may, for example, have dimensions ranging up to 3.21 m×6 m or 3.21 m×5.50 m or 3.21 m×5.10 m or 3.21 m×4.50 m (“PLF” glass sheets) or even, for example, 3.21 m×2.55 m or 3.21 m×2.25 m (“DLF” glass sheets).

The glass sheet according to the invention may be between 0.1 and 25 mm in thickness. Advantageously, in the case of a touch-panel application, the glass sheet according to the invention may be between 0.1 and 6 mm in thickness. Preferably, in the case of a touch-screen application, for reasons of weight, the glass sheet according to the invention will be 0.1 to 2.2 mm in thickness.

According to the invention, the composition of the invention comprises a total iron content (expressed in terms of Fe₂O₃) ranging from 0.002 to 0.06% by weight relative to the total weight of the glass. A total iron content (expressed in Fe₂O₃ form) lower than or equal to 0.06% by weight allows the IR transmission of the glass sheet to be further increased. The minimum value ensures that the cost of the glass is not increased too much as such low iron values often require very pure, expensive batch materials or else purification of the latter. Preferably, the composition comprises a total iron content (expressed in Fe₂O₃ form) ranging from 0.002 to 0.04% by weight relative to the total weight of the glass. Most preferably, the composition comprises a total iron content (expressed in Fe₂O₃ form) ranging from 0.002 to 0.02% by weight relative to the total weight of the glass.

According to one embodiment of the invention, the composition of the invention comprises a cobalt content (expressed in CoO form) ranging from 0.005 to 1% by weight relative to the total weight of the glass.

According to one advantageous embodiment of the invention, the composition of the invention comprises a cobalt content (expressed in CoO form) ranging from 0.001 to 0.5% by weight relative to the total weight of the glass, and preferably from 0.001 to 0.2% or even from 0.001 to 0.1%, indeed even from 0.001 to 0.05% or even from 0.001 to 0.02%. Such cobalt content ranges allow a high transmission in the IR to be obtained without too greatly degrading the aesthetic appearance and colouring of the glass sheet.

According to another advantageous embodiment of the invention, the composition of the invention comprises a cobalt content (expressed in CoO form) ranging from 0.005 to 0.5% by weight relative to the total weight of the glass, and preferably from 0.005 to 0.2% or from 0.005 to 0.1%, or even better from 0.005 to 0.05%. Most preferably, the composition of the invention comprises a cobalt content (expressed in CoO form) ranging from 0.002 to 0.1% or from 0.002 to 0.05%, or even better from 0.002 to 0.02%. Such cobalt content ranges allow an even better transmission in the IR to be obtained.

According to another embodiment of the invention, the composition comprises an Fe²⁺ content (expressed in FeO form) lower than 20 ppm. This content range allows very satisfactory properties to be obtained, in particular in terms of transmission of IR. Preferably, the composition comprises an Fe²⁺ content (expressed in FeO form) lower than 10 ppm. Most preferably, the composition comprises an Fe²⁺ content (expressed in FeO form) lower than 5 ppm.

According to the invention, the glass sheet possesses a high transmission in the IR. More precisely, the glass sheet of the present invention possesses a high transmission in the near infrared.

To quantify good transmission of the glass in the infrared range, in the present description, the absorption coefficient at a wavelength of 1050 nm will be used, which, this being the case, must be as low as possible in order to obtain a good transmission. The absorption coefficient is defined by the ratio of the absorbance to the length of the optical path traced by an electromagnetic ray in a given medium. It is expressed in m⁻¹. It is therefore independent of the thickness of the material but depends on the wavelength of the absorbed radiation and on the chemical nature of the material.

In the case of glass, the absorption coefficient (μ) at a chosen wavelength λ may be calculated from a measurement of the transmission (T) and refractive index n of the material (thick=thickness), the values of n, ρ and T depending on the chosen wavelength λ:

$$μ = - \frac{1}{thick} \cdot ln [ \frac{- {( 1 - ρ )}^{2} + \sqrt{{( 1 - ρ )}^{4} + 4 \cdot {T}^{2} \cdot {ρ}^{2}}}{2 \cdot T \cdot {ρ}^{2}} ]$$

where ρ=(n−1)²/(n+1)²

Advantageously, the glass sheet according to the invention has an absorption coefficient at a wavelength of 1050 nm lower than 5 m⁻¹. Preferably, the glass sheet according to the invention has an absorption coefficient at a wavelength of 1050 nm lower than or equal to 2 m⁻¹. Most preferably, the glass sheet according to the invention has an absorption coefficient at a wavelength of 1050 nm lower than or equal to 1 m⁻¹.

Also advantageously, the glass sheet according to the invention has an absorption coefficient at a wavelength of 950 nm lower than 5 m⁻¹. Preferably, the glass sheet according to the invention has an absorption coefficient at a wavelength of 950 nm lower than or equal to 2 m⁻¹. Most preferably, the glass sheet according to the invention has an absorption coefficient at a wavelength of 950 nm lower than or equal to 1 m⁻¹.

Also advantageously, the glass sheet according to the invention has an absorption coefficient at a wavelength of 850 nm lower than 5 m⁻¹. Preferably, the glass sheet according to the invention has an absorption coefficient at a wavelength of 850 nm lower than or equal to 2 m⁻¹. Most preferably, the glass sheet according to the invention has an absorption coefficient at a wavelength of 850 nm lower than or equal to 1 m⁻¹.

According to one embodiment of the invention, the composition of the glass sheet may comprise, in addition to impurities, especially contained in the batch materials, a small proportion of additives (such as agents promoting melting or fining of the glass) or elements due to dissolution of the refractories forming the melting furnaces.

According to one advantageous embodiment of the invention, the composition of the glass sheet may furthermore comprise one or more other colouring agents, in a suitable amount depending on the desired effect. This (these) colouring agent(s) may, for example, serve to “neutralize” the colour generated by the presence of the cobalt and thus make the colouring of the glass of the invention more neutral, i.e. colourless. Alternatively, this (these) colouring agent(s) may serve to obtain a desired colour other than that generated by the presence of the cobalt.

According to another advantageous embodiment of the invention, combinable with the preceding embodiment, the glass sheet may be coated with a layer or film that allows the colour generated by the presence of the cobalt to be modified or neutralized (for example a coloured PVB film).

The glass sheet according to the invention may advantageously be chemically or thermally tempered.

According to one embodiment of the invention, the glass sheet is coated with at least one thin, transparent and electrically conductive layer. A thin, transparent and conductive layer according to the invention may, for example, be a layer based on SnO₂:F, SnO₂:Sb or ITO (indium tin oxide), ZnO:Al or even ZnO:Ga.

According to another advantageous embodiment of the invention, the glass sheet is coated with at least one antireflective (or anti-reflection) layer. This embodiment is obviously advantageous in the case where the glass sheet of the invention is used as the front face of a screen. An antireflective layer according to the invention may, for example, be a layer based on low-refractive-index porous silica or it may be made up of a number of strata (multilayer), especially a multilayer of dielectric layers, said multilayer containing low- and high-refractive-index layers in alternation and terminating with a low-refractive-index layer.

According to another embodiment, the glass sheet is coated with at least one anti-smudge layer or has been treated so as to limit/prevent smudges from soiling it. This embodiment is also advantageous in the case where the glass sheet of the invention is used as the front face of a touch screen. Such a layer or treatment may be combined with a thin, transparent and electrically conductive layer deposited on the opposite face. Such a layer may be combined with an antireflective layer deposited on the same face, the anti-smudge layer being placed on the exterior of the multilayer and therefore covering the antireflective layer.

Depending on the desired applications and/or properties, other layers may be deposited on one and/or the other face of the glass sheet according to the invention.

Invention also relates to a touch screen or touch panel or touch pad comprising at least one glass sheet according to the invention, defining a touch surface. According to this embodiment, the touch screen or touch panel or touch pad advantageously uses FTIR or PSD optical technology. In particular, for a screen, the glass sheet is advantageously placed over a display surface.

Finally, by virtue of its high transmission in the infrared, the glass sheet according to the invention may advantageously be used in a touch screen or touch panel or touch pad using what is called planar scatter detection (PSD) or even frustrated total internal reflection (FTIR) optical technology to detect the position of one or more objects (for example a finger or stylus) on a surface of said sheet.

### EXAMPLES

Batch materials were blended in powder form and placed in a crucible in order to be melted, the blend having the base composition given in the following table.

| | Content [% by |
|---|---|
| Base composition | weight] |
| SiO₂ | 72 |
| CaO | 9 |
| K₂O | 0.3 |
| Na₂O | 14 |
| SO₃ | 0.3 |
| A1₂O₃ | 0.8 |
| MgO | 4.2 |
| Total iron (expressed in Fe₂O₃) | 0.01 |

Two samples were prepared with different amounts of cobalt, the base composition remaining the same. Sample 1 (comparative example) corresponds to a prior-art “low iron” glass (what is called “extra clear” glass) containing no cobalt. Sample 2 corresponds to a glass-sheet composition according to the invention.

The optical properties of each glass sample in sheet form were measured and, in particular, the absorption coefficient was measured at wavelengths of 1050, 950 and 850 nm via a transmission measurement using a PerkinElmer Lambda 950 spectrophotometer equipped with a 150 mm-diameter integration sphere, the sample being placed in the entrance aperture of the sphere for the measurement.

The following table shows the relative variation (Δ) in the absorption coefficient, at wavelengths of 1050, 950 and 850 nm, obtained for sample 2 according to the invention, with respect to the corresponding value obtained for the reference sample i.e. sample 1.

| | ppm platinum | Δ absorption | Δ absorption | Δ absorption |
|---|---|---|---|---|
| | (expressed in | coefficient at | coefficient at | coefficient at |
| | CoO form) | 1050 nm (m⁻¹) | 950 nm (m⁻¹) | 850 nm (m⁻¹) |
| Sample 2 | 15 | 0% | −14% | −15% |
| (invention) | | | | |

These results show that adding cobalt, in a content range according to the invention, allows the absorption coefficient at wavelengths of 950 and 850 nm to be decreased, and therefore, generally, the absorption of radiation in the near infrared to be decreased.

1. A glass sheet having a composition that comprises, in an amount expressed in percentages by total weight of glass:

| | |
|---|---|
| SiO₂ | 55-78% |
| Al₂O₃ | 0-18% |
| B₂O₃ | 0-18% |
| Na₂O | 5-20% |
| CaO | 0-15% |
| MgO | 0-10% |
| K₂O | 0-10% |
| BaO | 0-5% |
| total iron (expressed in Fe₂O₃ form) | 0.002-0.06%; |

wherein the composition comprises a cobalt content (expressed in CoO form) ranging from 0.001 to 1% by weight relative to the total weight of the glass.

2. The glass sheet of claim 1, wherein the composition comprises a cobalt content (expressed in CoO form) ranging from 0.005 to 0.5% by weight relative to the total weight of the glass.

3. The glass sheet of claim 1, wherein the composition comprises a cobalt content (expressed in CoO form) ranging from 0.001 to 0.1% by weight relative to the total weight of the glass.

4. The glass sheet of claim 3, wherein the composition comprises a cobalt content (expressed in CoO form) ranging from 0.002 to 0.05% by weight relative to the total weight of the glass.

5. The glass sheet of claim 4, wherein the composition comprises a cobalt content (expressed in CoO form) ranging from 0.002 to 0.02% by weight relative to the total weight of the glass.

6. The glass sheet of claim 1, wherein the composition comprises a total iron content (expressed in Fe₂O₃ form) of 0.002 to 0.04% by weight relative to the total weight of the glass.

7. The glass sheet of claim 6, wherein the composition has a total iron content (expressed in Fe₂O₃ form) of 0.002 to 0.02% by weight relative to the total weight of the glass.

8. The glass sheet claim 1, wherein the composition has an Fe²⁺ content (expressed in FeO form) of lower than 20 ppm.

9. The glass sheet of claim 8, wherein the composition has an Fe²⁺ content (expressed in FeO form) of lower than 10 ppm.

10. The glass sheet of claim 9, wherein the composition has an Fe²⁺ content (expressed in FeO form) of lower than 5 ppm.

11. The glass sheet of claim 1, wherein the glass sheet is coated with at least one anti-smudge layer or has been treated so as to limit/prevent smudges from soiling the glass sheet.

12. A touch screen, touch panel or touch pad, comprising at least one glass sheet of claim 1, defining a touch surface.

13. The touch screen, touch panel or touch pad of claim 12, employing FTIR or PSD optical technology.

14. A method, comprising detecting the position of an object on a surface of a glass sheet of claim 1 with a touch screen, touch panel or touch pad comprising the glass sheet by employing FTIR or PSD optical technology.
